(19) United States
(12) Patent Application Publication
(10) Pub. No.: US 2004/0234872 A1
(43) Pub. Date: Nov. 25, 2004

(54) Negative type colored photosensitive composition

(76) Inventor: Naofumi Horiguchi, Tokyo (JP)

Correspondence Address: Kevin S Lemack, Nields & Lemack, Suite 7, 176 E Main Street, Westboro, MA, 01581, US

(21) Appl. No.: 10/486,281

(22) PCT Filed: Aug. 21, 2002
(86) PCT No.: PCT/JP02/08396

(30) Foreign Application Priority Data
Aug. 23, 2001 (JP) 2001-252845

(51) Int. Cl. G02F 1/1335; G02B 5/20

(52) U.S. Cl. 430/7; 430/270.1; 349/106; 257/440

(57) ABSTRACT

A negative type colored photosensitive composition for color filter production which is excellent in smoothness, resolution, shape, heat resistance, light resistance, spectral properties, production step simplification, and sensitivity and has satisfactory storage stability. The composition comprises a binder polymer, a photopolymerizable monomer or oligomer, a photopolymerization initiator, a polymerization inhibitor, a dye, and an organic solvent.

### FIELD OF THE INVENTION

The present invention relates to a negative type colored photosensitive composition which is preferably used for producing a color filter for use in a liquid crystal display element and a solid-state image-pickup element and its colored cured-film pixels, and also concerns a liquid crystal display element and a solid-state image-pickup element containing such a composition.

### BACKGROUND OF THE INVENTION

In order to provide coloration for a liquid crystal display element, such as a liquid crystal display device (LCD) and the like that are typically applied to notebook-type personal computers and liquid crystal televisions, and for a solid-state image-pickup element that is typically represented by a charge-coupled device (CCD), which is used for an input device for use in digital cameras, color copying machines and the like, a color filter is required. As a method for producing color filters for use in these liquid crystal display devices and charge-coupled devices, a dyeing method, an electrodeposition method, a printing method and a pigment-dispersion method have been known.

In the dyeing method, a color filter is prepared by dyeing a dyeing base material made of a natural resin such as gelatin, glue and casein or a synthetic resin such as amine-modified polyvinyl alcohol with a dye such as an acidic dye. This method provides superior spectral properties and color purity. However, this method tends to cause color irregularities because it is difficult to uniformly control dyeing and adhering properties during manufacturing, and upon dyeing, resist printing is required, resulting in a complex process.

In the electrodeposition method, a transparent electrode is preliminarily formed with a predetermined pattern, and a voltage is applied to an ionized resin containing a pigment dissolved or dispersed in a solvent so that a colored image is formed on the pattern to prepare a color filter. The electrodeposition method requires processes including a film-forming process of a transparent electrode for use in forming a color filter and an etching process, in addition to processes for forming a transparent electrode for use in displaying. Upon occurrence of a short-circuiting during these additional processes, a defective wiring occurs, resulting in a reduction in the yield. Moreover, it is difficult, in principle, to apply this method to arrays other than stripe arrays, for example, mosaic arrays. Further, it is difficult to control transparent electrodes.

The printing method is a simple method which forms a color filter through an offset printing process and the like by using ink in which a pigment is dispersed in a thermosetting resin or an ultraviolet-ray setting resin. It is difficult, however, to carry out a filtering process, since the ink to be used has high viscosity, and this method is susceptible to defectives due to dusts, foreign matters and gelled portions of ink binder. Further, this method tends to have problems with position accuracy, line-width accuracy and plane smoothness resulting from insufficient printing precision.

In the pigment dispersion method, a color filter is prepared through a photolithography method by using a colored photosensitive composition in which a pigment is uniformly dispersed in a photosensitive resin composition. Since a pigment is used, this method provides sufficient heat resistance and light resistance, and since a patterning process is carried out through a photolithography method, this method also provides sufficient position accuracy so that it is preferably applied to manufacturing processes for a color filter for use in high-precision color displays with large screens. However, in comparison with dyes, pigments have insufficient spectral properties and color purity, and in comparison with dyes capable of carrying out spectral adjustments on all colors, pigments have fewer variations. Further, pigments tend to cause surface roughness in the resulting pixels.

Among the methods described above, the pigment dispersion method has been mainly used, at present, as a method for manufacturing color filters. In this method, however, there have been strong demands for a colored photosensitive composition which is superior in all the following properties in addition to preservation stability: smoothness, resolution, shape properties, heat resistance, light resistance, spectral properties, simplicity of production steps and sensitivity.

The present invention relates to a negative-type colored photosensitive composition which has superior properties of both the dyeing method and the pigment dispersion method, that is, superior properties in smoothness, resolution, shape properties, heat resistance, light resistance, spectral properties, simplicity of manufacturing process and sensitivity, and its objective is to provide a negative-type colored photosensitive composition that also exerts superior preservation stability without impairing the conventional performances.

### DISCLOSURE OF THE INVENTION

Namely, the present invention relates to the following compositions, methods and elements:

(1) A negative-type colored photosensitive composition comprising a binder polymer, a photopolymerizable monomer or oligomer, a photopolymerization initiator, a polymerization inhibitor, a dye and an organic solvent, in which the polymerization inhibitor is an N-nitrosophenyl hydroxylamine salt.

(2) The negative-type colored photosensitive composition according to the aspect (1), in which the N-nitrosophenyl hydroxylamine salt is an ammonium salt or a metal salt of N-nitrosophenyl hydroxylamine.

(3) The negative-type colored photosensitive composition according to the aspect (1) or (2), in which the binder polymer is an alkali soluble resin.

(4) The negative-type colored photosensitive composition according to the aspect (1) or (2), in which the binder polymer is a water-soluble resin.

(5) The negative-type colored photosensitive composition according to any one of the aspects (1) to (4), in which the dye is a dye that is soluble to an organic solvent.

(6) A method for preparing a color filter in which: a negative-type colored photosensitive composition described in any one of the aspects (1) to (5) is applied to a substrate, and after exposure to light, the exposed portion is cured, and the non-exposed portion is developed and removed by an active agent aqueous solution and/or an alkaline aqueous solution, and is rinsed by water.

(7) A color filter in which among the color filter pixels prepared by the method according to the aspect (6), at least pixels of one color are cured films of the negative-type colored photosensitive composition according to any one of the aspects (1) to (5).

(8) A liquid crystal display element having a color filter described in the aspect (7).

(9) A solid-state image-pickup element having a color filter described in the aspect (7).

### BEST MODE FOR CARRYING OUT THE INVENTION

The following description will further explain the invention in detail. In the following descriptions, “parts” refer to “mass parts” and “%” refers to “mass %”, unless otherwise indicated.

The negative-type colored photosensitive composition of the present invention is characterized by containing a binder polymer, a photopolymerizable monomer or oligomer, a photopolymerization initiator, a dye, an N-nitrosophenyl hydroxylamine salt and an organic solvent.

As the binder polymer to be used in the present invention, those polymers, which function as a binder for a colorant, and are soluble to a developer used in developing processes upon manufacturing a color filter, are used. Preferable examples include an alkali soluble resin and a water-soluble resin.

As the alkali-soluble resin to be used in the present invention, a polymer having a carboxylic group is preferably used, and in particular, a copolymer (hereinafter, referred to simply as “carboxylic group containing copolymer”) of a monomer mixture composed of an ethylenic unsaturated monomer having at least one carboxylic group (hereinafter, referred to simply as “carboxylic group containing unsaturated monomer”) and another copolymerizable ethylenic unsaturated monomer (hereinafter, referred to as “another unsaturated monomer”) is preferably used.

As the above-mentioned carboxylic group containing unsaturated monomer, examples include: unsaturated monocarboxylic acids, such as chain unsaturated monocarboxylic acids having 2 to 3 carbon atoms like acrylic acid, methacrylic acid, crotonic acid, α-chloroacrylic acid and ethacrylic acid, and cyclic unsaturated monocarboxylic acids like cinnamic acid; unsaturated dicarboxylic acids (anhydrides) such as maleic acid, maleic anhydride, fumaric acid, itaconic acid, itaconic anhydride, citraconic acid, citraconic anhydride and mesaconic acid; and unsaturated polycarboxylic acids (anhydrides) having more than two carboxylic groups. These carboxylic group containing ethylenic unsaturated monomers may be used alone or as an admixture thereof.

As the another unsaturated monomer, examples include: aromatic vinyl compounds, such as styrene, α-methyl styrene, o-vinyl toluene, m-vinyl toluene, p-vinyl toluene, o-chlorostyrene, m-chlorostyrene, p-chlorostyrene and p-methoxystyrene; unsaturated carboxylic acid esters, such as methyl acrylate, methyl methacrylate, ethyl acrylate, ethyl methacrylate, n-propyl acrylate, i-propyl acrylate, n-propyl methacrylate, i-propyl methacrylate, n-butyl acrylate, i-butyl acrylate, sec-butyl acrylate, t-butyl acrylate, n-butyl methacrylate, i-butyl methacrylate, sec-butyl methacrylate, t-butyl methacrylate, 2-hydroxyethyl acrylate, 2-hydroxyethyl methacrylate, benzyl acrylate and benzyl methacrylate, preferably unsaturated carboxylic acid esters derived from chain or cyclic alcohols having 1 to 7 carbon atoms and unsaturated carboxylic acids having 4 or less carbon atoms; unsaturated carboxylic acid aminoalkyl esters, such as 2-aminoethyl acrylate, 2-aminoethyl methacrylate, 2-aminopropyl acrylate, 2-aminopropyl methacrylate, 3-aminopropyl acrylate and 3-aminopropyl methacrylate; unsaturated carboxylic acid glycidyl esters, such as glycidyl acrylate and glycidyl methacrylate; carboxylic acidvinyl esters, such as vinyl acetate, vinyl propionate, vinyl butyrate and vinyl benzoate; unsaturated ethers, such as vinyl methyl ether, vinyl ethyl ether, allyl glycidyl ether and methallyl glycidyl ether; cyano-group bearing vinyl compounds such as acrylonitrile, methacrylonitrile, α-chloroacrylonitrile and vinylidene cyanide; unsaturated amides or unsaturated imides, such as acrylamide, methacrylamide, α-chloroacrylamide, N-(2-hydroxyethyl) acrylamide, N-(2-hydroxyethyl) methacrylamide and maleimide; aliphatic conjugated dienes, such as 1,3-butadiene, isoprene and chloroprene; and macromonomers having a monoacryloyl group or a monomethacryloyl group at a terminal of a polymer molecular chain, such as polystyrene, polymethyl acrylate, polymethyl methacrylate, poly n-butyl acrylate, poly n-butyl methacrylate and polysilicone. These another unsaturated monomer may be used alone or as an admixture thereof.

As the carboxylic group containing copolymer, preferable examples include: copolymers of acrylic acid and/or methacrylic acid and at least one kind of another unsaturated monomer selected from the group consisting of methyl methacrylate, 2-hydroxyethyl acrylate, 2-hydroxyethyl methacrylate, benzyl acrylate, benzyl methacrylate, styrene, polystyrene macromonomer and polymethyl methacrylate macromonomer. Specific examples of the preferred carboxylic group containing copolymer include: acrylic acid copolymers, such as an acrylic acid/benzyl acrylate copolymer, an acrylic acid/benzyl acrylate/styrene copolymer, an acrylic acid/methyl acrylate/styrene copolymer, an acrylic acid/benzyl acrylate/polystyrene macromonomer copolymer, an acrylic acid/benzyl acrylate/polymethyl methacrylate macromonomer copolymer, an acrylic acid/methyl acrylate/polystyrene macromonomer copolymer, an acrylic acid/methyl acrylate/polymethyl methacrylate macromonomer copolymer, an acrylic acid/benzyl methacrylate copolymer, an acrylic acid/benzyl methacrylate/styrene copolymer, an acrylic acid/methyl methacrylate/styrene copolymer, an acrylic acid/benzyl methacrylate/polystyrene macromonomer copolymer, an acrylic acid/benzyl methacrylate/polymethyl methacrylate macromonomer copolymer, an acrylic acid/methyl methacrylate/polystyrene macromonomer copolymer, an acrylic acid/methyl methacrylate/polymethyl methacrylate macromonomer copolymer, an acrylic acid/2-hydroxyethyl methacrylate/benzyl methacrylate/polystyrene macromonomer copolymer and an acrylic acid/2-hydroxyethyl methacrylate/benzyl methacrylate/polymethyl methacrylate macromonomer copolymer; and methacrylic acid copolymers, such as a methacrylic acid/benzyl acrylate copolymer, a methacrylic acid/benzyl acrylate/styrene copolymer, a methacrylic acid/methyl acrylate/styrene copolymer, a methacrylic acid/benzyl acrylate/polystyrene macromonomer copolymer, a methacrylic acid/benzyl acrylate/polymethyl methacrylate macromonomer copolymer, a methacrylic acid/methyl acrylate/polystyrene macromonomer copolymer, a methacrylic acid/methyl acrylate/polymethyl methacrylate macromonomer copolymer, a methacrylic acid/benzyl methacrylate copolymer, a methacrylic acid/benzyl methacrylate/styrene copolymer, a methacrylic acid/methyl methacrylate/styrene copolymer, a methacrylic acid/benzyl methacrylate/polystyrene macromonomer copolymer, a methacrylic acid/benzylmethacrylate/polymethylmethacrylate macromonomer copolymer, a methacrylic acid/methylmethacrylate/polystyrene macromonomer copolymer, a methacrylic acid/methyl methacrylate/polymethyl methacrylate macromonomer copolymer, a methacrylic acid/2-hydroxyethyl methacrylate/benzyl methacrylate/polystyrene macromonomer copolymer and a methacrylic acid/2-hydroxyethyl methacrylate/benzyl methacrylate/polymethyl methacrylate macromonomer copolymer.

Moreover, a polymer formed by further introducing an unsaturated double bond to a side chain of the above-mentioned copolymer is also useful.

Examples thereof include: compounds which are formed by allowing acrylate having an alcoholic hydroxyl group, such as hydroxy ethyl acrylate, or acrylate having an epoxy group, such as glycidyl methacrylate, to react with a maleic anhydride portion of a copolymer of maleic anhydride with a polymerizable monomer, such as styrene, vinyl phenol, acrylic acid, acrylic acid esters and acrylic amid, to form a half ester; and compounds which are formed by allowing acrylic acid to further react with an —OH group of a copolymer of acrylic acid and acrylic acid esters with an acrylate having an alcoholic hydroxyl group such as hydroxyethyl acrylate.

As water-soluble resin, examples include: resins such as acryl based, methacryl based, polyvinyl alcohol based, polyvinyl pyrrolidone based and acryloyl morpholine based resins. More specifically, theacryl based resins include: polymers of acrylic acid, sodium acrylate, acryl amide and the like and copolymers thereof. Examples of the methacryl based resins include: polymers of methacrylic acid, sodium methacrylate, 2-hydroxy methacrylic acid and the like and copolymers thereof.

In the present invention, the binder polymers may be used alone or as an admixture thereof. The amount of the binder polymer is normally 5 to 80%, preferably 10 to 60%, more preferably 15 to 35%, with respect to the entire solid components of the negative-type colored photosensitive composition. When the amount of the binder polymer is less than 5%, for example, the alkali developing property tends to deteriorate, and base surface stains and residual films tend to occur in areas other than portions used for forming pixels, and in the case when the amount exceeds 80%, the dye concentration is relatively lowered, making it sometimes difficult to achieve a desired color density by a thin film.

The weight average molecular weight (Mw) of the copolymer as the binder polymer is normally to 2000 to 1000000, preferably 3000 to 400000. When the weight average molecular weight is not more than 2000, or not less than 1000000, the sensitivity and the developing property deteriorate.

As the photopolymerizable monomer or oligomer, in the present invention, examples include: mono(metha)acrylates such as 2-hydroxyethyl(metha)acrylate, 2-hydroxypropyl(metha)acrylate, 2-ethylhexyl(metha)acrylate and glycerol(metha)acrylate; di(metha)acrylates such as ethylene glycol di(metha)acrylate, ueediethylene glycol di(metha)acrylate, triethylene glycol(metha)acrylate, tetraethylene glycol(metha)acrylate, pentaerythritol di(metha)acrylate, bisphenol-A-type epoxide di(metha)acrylate, bisphenol-F-type epoxide di(metha)acrylate and bisphenol-fluorene-type epoxide di(metha)acrylate; tri(metha)acrylates, such as trimethylol propane tri(metha)acrylate and pentaerythritol tri(metha)acrylate; tetra(metha)acrylates such as pentaerythritol tetra(metha)acrylate; and hexa(metha)acrylates such as dipentaerythritol hexa(metha)acrylate. Among these photopolymerizable monomers, mono-, di-, tri-, tetra-, penta- or hexa(metha)acrylate, derived from pentaerythritol and (metha)acrylic acid, are preferably used.

These materials may be used alone or as an admixture thereof. The total amount of the photopolymerizable monomer or oligomer is normally 5 to 60%, preferably 10 to 50%, more preferably 25 to 45%, with respect to the entire solid components of the negative-type colored photosensitive composition.

As the photopolymerization initiator to be used in the present invention, those having a sensitivity to g-line (436 nm), h-line (405 nm) and i-line (365 nm) of ultraviolet rays emitted from an ultrahigh pressure mercury lamp which is generally used as an exposure light source, are preferably used.

The total amount of the photopolymerization initiator is normally 0.5 to 50%, preferably 1 to 30%, more preferably 15 to 25%, with respect to the total solid components in the negative-type colored photosensitive composition.

As the photopolymerization initiator, examples include: benzil, benzoinmethyl ether, benzoinbutylmethyl ether, benzoin propyl ether, benzophenone, 3,3′-dimethyl-4-methoxy benzophenone, benzoyl benzoic acid, an ester of benzoyl benzoic acid, 4-benzoyl-4′-methyldiphenyl sulfide, benzyldimethyl ketal, 2-butoxyethyl-4-methyl aminobenzoate, chlorothioxanthone, methyl thioxanthone, ethyl thioxanthone, isopropyl thioxanthone, dimethyl thioxanthone, diethyl thioxanthone, diisopropyl thioxanthone, dimethyl aminomethyl benzoate, dimethyl aminobenzoic acid isoamide esters, 1-(4-dodecylphenyl)-2-hydroxy-methylpropane-1-one, 1-hydroxycyclohexyl phenyl ketone, 2-hydroxy-2-methyl-1-phenylpropane-1-one, 1-(4-isopropylphenyl)-2-hydroxy-2-methylpropane-1-one, methylbenzoyl formate, 2-benzyl-2-dimethylamino-1-(4-morpholinophenyl)butane-1-one, 2,2′-bis(2-chlorophenyl)-4,4′,5,5′-tetraphenyl bisimidazole, 2,2′-bis(2-chlorophenyl)-4,4′,5,5′-tetra(4-methoxyphenyl) bisimidazole, 2,4-bis(trichloromethyl)-6-(4-methoxyphenyl)-1,3,5-s-triazine, 2,4,6-tris(trichloromethyl)-1,3,5-s-triazine, 2,4-bis(tribromomethyl)-6-(4′-methoxyphenyl)-1,3,5-s-triazine, 2,4,6-tris(tribromomethyl)-1,3,5-s-triazine, 2,4-bis(trichloromethyl)-6-(1,3-benzodioxolane-5-yl)-1,3,5-s-triazine, 2-benzophenone, benzoyl benzoic acid, 1-(4-phenylsulfanylphenyl) butane-1,2-dione-2-oxime-O-benzoate, 1-(4-methylsufanylphenyl)butane-1,2-dione-2-oxime-O-acetate and 1-(4-methylsulfanylphenyl)butane-1-one oxime-O-acetate.

As the N-nitrosophenyl hydroxylamine salt, in the present invention, examples include ammonium salts and metal salts. Examples of the metal salts include: aluminum salts and cerium salts. The N-nitrosophenyl hydroxylamine salts may be used as an admixture thereof, and may be used in combination with other polymerization inhibitors (for example, p-methoxy phenol, hydroquinone, pyrogallol, tert-butyl catechol, cuprous chloride, 2,6-di-tert-butyl-p-cresol, etc.). The total amount of the polymerization inhibitors including the N-nitrosophenyl hydroxylamine salt is normally 0.0001 to 5%, preferably 0.001 to 3%, more preferably 0.005 to 2%, with respect to the total solid components of the negative-type colored photosensitive composition.

As the dye, those having spectral properties applicable to color filters are preferably used. In order to form a color filter having fine pixels that are superior in spectral properties and color purity, dyes are preferably used, and those dyes which are soluble to an organic solvent are properly selected and used. Those dyes include acidic dyes, basic dyes, direct dyes, sulfur dyes, vat dyes, naphthol dyes, reactive dyes, disperse dyes and the like. Applicable dyes are listed in Dye Handbook (Maruzen Co., Ltd.), Dye Chemistry (Shikisensha Co., Ltd.) and Color Chemical Dictionary (CMC Publishing Co., Ltd.)

Specific examples of the acidic dyes include: C. I. Acid Red 6, C. I. Acid Red 11, C. I. Acid Red 26, C. I. Acid Red 60, C. I. Acid Red 88, C. I. Acid Red 111, C. I. Acid Red 186, C. I. Acid Red 215, C. I. Acid Green 25, C. I. Acid Green 27, C. I. Acid Blue 22, C. I. Acid Blue 25, C. I. Acid Blue 40, C. I. Acid Blue 78, C. I. Acid Blue 92, C. I. Acid Blue 113, C. I. Acid Blue 129, C. I. Acid Blue 167, C. I. Acid Blue 230, C. I. Acid Yellow 17, C. I. Acid Yellow 23, C. I. Acid Yellow 25, C. I. Acid Yellow 36. C. I. Acid Yellow 38, C. I. Acid Yellow 42. C. I. Acid Yellow 44, C. I. Acid Yellow 72, C. I. Acid Yellow 78.

Specific examples of the basic dyes include: C. I. Basic Red 1, C. I. Basic Red 2, C. I. Basic Red 13, C. I. Basic Red 14, C. I. Basic Red 22, C. I. Basic Red 27, C. I. Basic Red 29, C. I. Basic Red 39, C. I. Basic Green 3, C. I. Basic Green 4, C. I. Basic Blue 3, C. I. Basic Blue 9, C. I. Basic Blue 41, C. I. Basic Blue 66, C. I. Basic Violet 1, C. I. Basic Violet 3, C. I. Basic Violet 18, C. I. Basic Violet 39, C. I. Basic Yellow 11, C. I. Basic Yellow 23, C. I. Basic Yellow 25, C. I. Basic Yellow 28, C. I. Basic Yellow 41.

Specific examples of the direct dyes include: C. I. Direct Red 4, C. I. Direct Red 23, C. I. Direct Red 31, C. I. Direct Red 75, C. I. Direct Red 76, C. I. Direct Red 79, C. I. Direct Red 80. C. I. Direct Red 81, C. I. Direct Red 83, C. I. Direct Red 84. C. I. Direct Red 149, C. I. Direct Red 224, C. I. Direct Green 26, C. I. Direct Green 28, C. I. Direct Blue 71, C. I. Direct Blue 78, C. I. Direct Blue 98, C. I. Direct Blue 106, C. I. Direct Blue 108, C. I. Direct Blue 192, C. I. Direct Blue 201, C. I. Direct Violet 51, C. I. Direct Yellow 26, C. I. Direct Yellow 27, C. I. Direct Yellow 28, C. I. Direct Yellow 33, C. I. Direct Yellow 44, C. I. Direct Yellow 50, C. I. Direct Yellow 86, C. I. Direct Yellow 142, C. I. Direct Orange 26, C. I. Direct Orange 29, C. I. Direct Orange 34, C. I. Direct Orange 37, C. I. Direct Orange 72.

Specific examples of the sulfur dyes include: C. I. Sulphur Red 5, C. I. Sulphur Red 6, C. I. Sulphur Red 7, C. I. Sulphur Green 2, C. I. Sulphur Green 3, C. I. Sulphur Green 6, C. I. Sulphur Blue 2, C. I. Sulphur Blue 3, C. I. Sulphur Blue 7, C. I. Sulphur Blue 9, C. I. Sulphur Blue 13, C. I. Sulphur Blue 15, C. I. Sulphur Violet 2, C. I. Sulphur violet 3, C. I. Sulphur Violet 4, C. I. Sulphur Yellow 4.

Specific examples of the vat dyes include: C. I. Vat Red 13, C. I. Vat Red 21, C. I. Vat Red 23, C. I. Vat Red 28, C. I. Vat Red 29, C. I. Vat Red 48, C. I. Vat Green 3, C. I. Vat Green 5, C. I. Vat Green 8, C. I. Vat Blue 6, C. I. Vat Blue 14, C. I. Vat Blue 26, C. I. Vat Blue 30, C. I. Vat Violet 1, C. I. Vat Violet 3, C. I. Vat Violet 9, C. I. Vat Violet 13, C. I. Vat Violet 15, C. I. Vat Violet 16, C. I. Vat Yellow 2, C. I. Vat Yellow 12, C. I. Vat Yellow 20, C. I. Vat Yellow 33, C. I. Vat Orange 2, C. I. Vat Orange 5, C. I. Vat Orange 11, C. I. Vat Orange 15, C. I. Vat Orange 18, C. I. Vat Orange 20.

Specific examples of the naphthol dyes include: C. I. Azoic Coupling Component 2, C. I. Azoic Coupling Component 3, C. I. Azoic Coupling Component 4, C. I. Azoic Coupling Component 5, C. I. Azoic Coupling Component 7, C. I. Azoic Coupling Component 8, C. I. Azoic Coupling Component 9, C. I. Azoic Coupling Component 10, C. I. Azoic Coupling Component 11, C. I. Azoic Coupling Component 13, C. I. Azoic Coupling Component 32, C. I. Azoic Coupling Component 37, C. I. Azoic Coupling Component 41, C. I. Azoic Coupling Component 48.

Specific examples of the reactive dyes include: C. I. Reactive Red 8, C. I. Reactive Red 22, C. I, Reactive Red 46, C. I. Reactive Red 120, C. I. Reactive Blue 1, C. I. Reactive Blue 2, C. I. Reactive Blue 7, C. I. Reactive Blue 19, C. I. Reactive Violet 2, C. I. Reactive Violet 4, C. I. Reactive Yellow 1, C. I. Reactive Yellow 2, C. I. Reactive Yellow 4, C. I. Reactive Yellow 14, C. I. Reactive Yellow 16, C. I. Reactive Orange 1, C. I. Reactive Orange 4, C. I. Reactive Orange 7, C. I. Reactive Orange 13, C. I. Reactive Orange 16, C. I. Reactive Orange 20.

Specific examples of the disperse dyes include: C. I. Disperse Red 4, C. I. Disperse Red 11, C. I. Disperse Red 54, C. I. Disperse Red 55, C. I. Disperse Red 58, C. I. Disperse Red 65, C. I. Disperse Red 73, C. I. Disperse Red 54, C. I. Disperse Red 127, C. I. Disperse Red 141, C. I. Disperse Red 129, C. I. Disperse Red 196, C. I. Disperse Red 210, C. I. Disperse Red 229, C. I. Disperse Red 354, C. I. Disperse Red 356, C. I. Disperse Blue 3, C. I. Disperse Blue 24, C. I. Disperse Blue 79, C. I. Disperse Blue 82, C. I. Disperse Blue 87, C. I. Disperse Blue 106, C. I. Disperse Blue 125, C. I. Disperse Blue 165, C. I. Disperse Blue 183, C. I. Disperse Violet 1, C. I. Disperse Violet 6, C. I. Disperse Violet 12, C. I. Disperse Violet 26, C. I. Disperse Violet 27, C. I. Disperse Violet 28, C. I. Disperse Yellow 3, C. I. Disperse Yellow 4, C. I. Disperse Yellow 5, C. I. Disperse Yellow 7, C. I. Disperse Yellow 23. C. I. Disperse Yellow 33, C. I. Disperse Yellow 42, C. I. Disperse Yellow 60, C. I. Disperse Yellow 64, C. I. Disperse Orange 13, C. I. Disperse Orange 29, C. I. Disperse Orange 30.

In general, dyes are difficult to be dissolved in an organic solvent. For example, in order to improve the solubility of a dye to an organic solvent, it has been known to use an amine salt dye, prepared by allowing an amine of primary or more class, for example, an organic amine such as n-propyl amine and ethylhexyl propionic acid amine, to react with, for example, an acidic dye, a basic dye or the like, and a sulfone amide-group containing dye, prepared by allowing an amine of primary or more class, for example, an organic amine such as n-propyl amine and ethylhexyl propionic acid amine, to react with, for example, a sulfonic acid group of an acidic dye, a basic dye or the like. These amine-modified dyes may also be used for the negative-type colored photosensitive composition of the present invention. Among these dyes, those containing metal desirably exert the effects of the present invention, and among these, transition-metal-containing dyes are preferably used.

The dyes may be used alone; however, two or more kinds of dyes may be mixed and dissolved to adjust color tones in order to provide desired spectral properties, by utilizing the feature of dyes capable of adjusting spectral properties to prepare various kinds of colors. The total amount of the dyes is 0.5 to 50%, preferably 10 to 40%, more preferably 15 to 20%, with respect to the entire solid components of the negative-type colored photosensitive composition.

The organic solvent preferably is able to dissolve binder polymer, a photopolymerizable monomer or oligomer, a photopolymerization initiator and a dye, which serve as components of the negative-type colored photosensitive composition. Examples of the organic solvent to be used include: benzenes such as benzene, toluene and xylene; cellosolves such as methyl cellosolve, ethyl cellosolve and butyl cellosolve; cellosolve acetates such as methylcellosolve acetate, ethylcellosolve acetate and butylcellosolve acetate; propylene glycol monoalkyl ether acetates, such as propyleneglycol monomethylether acetate, propyleneglycol monoethylether acetate and propyleneglycol monobutylether acetate; propionic acid esters such as methyl methoxypropionate, ethyl methoxypropionate, methyl ethoxypropionate and ethyl ethoxypropionate; lactic acid esters such as methyl lactate, ethyl lactate and butyl lactate; diethylene glycols such as diethyleneglycol monomethyl ether and diethyleneglycol monoethyl ether; acetic acid esters such as methyl acetate, ethyl acetate and butyl acetate; ethers such as dimethylether, diethylether, tetrahydrofran and dioxane; and ketones such as acetone, methyl ethyl ketone, methyl butyl ketone and cyclohexanone.

These solvents may be used alone or as an admixture thereof. The amount of the organic solvent is normally 50 to 2000 parts, preferably 100 to 1000 parts, more preferably 300 to 600 parts, with respect to 100 parts of the entire solid components of the negative-type colored photosensitive composition.

The negative-type colored photosensitive composition of the present invention is manufactured by stirring and dissolving the above-mentioned binder polymer, photopolymerizable monomer or oligomer, photopolymerization initiator, dye, polymerization inhibitor and organic solvent, by a dissolver, a homomixer or the like. Here, when the following optional components are used, the amount of these essential components is calculated with the optional components excluded.

To the negative-type colored photosensitive composition are further added, if necessary, various additives, such as a filler, a surface active agent, a thermal polymerization inhibitor, a contact accelerator, an antioxidant, an ultraviolet-ray absorbing agent, a coagulation inhibitor, a thermosetting resin and a thermal polymerization initiator. Among these, as the thermosetting resin, examples include epoxy resins such as bisphenol A diglycidyl ether, ethylene glycol diglycidyl ether, butanediol diglycidyl ether, hexanediol diglycidyl ether, dihydroxybiphenyl diglycidyl ether, diglycidyl phthalate and N,N-diglycidyl aniline, and melamine resins such as hexamethoxymethylmelamine.

The negative-type photosensitive composition of the present invention, thus obtained, is precisely filtered through a filter and the like so as to remove foreign matters and the like, prior to shipment as products.

The color filter of the present invention includes pixels of at least one color that are formed by a cured film of the above-mentioned negative-type colored photosensitive composition. For example, in the case of a color filter formed by three colors, the pixels of one color or two colors may be formed by the above-mentioned colored photosensitive composition, with the other pixels of the rest of the colors being formed by a pigment dispersion-type colored photosensitive composition containing a pigment, or all the pixels of the three colors may be formed by the negative-type photosensitive composition. As the pigment to be used in the pigment dispersion-type colored photosensitive composition, examples include: red pigments: C. I. Pigment Red 177, 254; green pigments: C. I. Pigment Green 7, 36; blue pigments: C. I. Pigment Blue 15:6, 60; yellow pigments: C. I. Pigment Yellow 83, 139, 150; magenta pigments: C. I. Pigment Red 81, 122, 209; and cyan pigments: C. I. Pigment Blue 15:3. These are adjusted so as to attain desired spectral properties, and added to the pigment dispersion-type photosensitive composition.

Upon manufacturing a color filter, for example, the negative-type colored photosensitive composition of the present invention is applied to a glass substrate, a silicon substrate or the like with a film thickness of 0.1 to 5 μm by a spin coating method, a roll coating method, a bar coating method or the like, and this is subjected to a pre-baking process to form a film. Next, a radiation (for example, an electron beam, ultraviolet rays, etc., preferably, ultraviolet rays) is applied to this film through a predetermined mask by a photolithography method, and the film is then developed by an active agent aqueous solution, an alkaline aqueous solution or an (active agent+alkali) aqueous solution so that the unexposed portions are removed, and after having been rinsed with water, this is subjected to a post-baking process and the like to obtain a colored cured-film pixel.

By using the color filter constituted by colored cured-film pixels of the negative-type colored photosensitive composition of the present invention, a liquid crystal display element can be manufactured. For example, this is manufactured with a structure in which a back light, a polarizing film, display electrodes, liquid crystal, an alignment film, common electrodes, a color filter of the present invention, a polarizing film and the like are laminated in this order. Further, a solid-state image-pickup element can be manufactured by placing a color filter layer of the present invention on a silicon wafer on which transferring electrodes and photodiodes have been placed beforehand, and then laminating a microlens thereon. Here, as the constituent colors of the color filter, primary colors include red, green and blue, and complementary colors include yellow, magenta, cyan and green.

### EXAMPLES

The following description only gives examples of the present invention, and is not intended to limit the scope of the present invention.

### Example 1

A negative-type photosensitive composition of the present invention was prepared by mixing the following components: 0.17 g of a resin (weight-average molecular weight 25000) composed of 18% by weight of methacrylic acid and 82% by weight of benzyl methacrylate, serving as a binder polymer; 0.17 g of Kayarad DPHA (dipentaerythritol hexacrylate; made by Nippon Kayaku Co., Ltd.) serving as a photopolymerizable monomer; 0.1 g of 2,4-bis(trichloromethyl)-6-(4-methoxyphenyl)-1,3,5-s-triazine serving as a photopolymerization initiator; 0.1 g of ORAZOL GN (made by Ciba Speciality Chemicals Inc.) serving as a dye; 3 g of ethyl lactate; and 0.0005 g of N-nitrosophenyl hydroxylamine ammonium salt (made by Wako Pure Chemical Industries, Ltd.) serving as a polymerization inhibitor.

### Comparative Example 1

A negative-type photosensitive composition for the purpose of comparison was prepared by mixing the following components: 0.17 g of a resin composed of 18% by weight of methacrylic acid and 82% by weight of benzyl methacrylate serving as a binder polymer; 0.17 g of Kayarad DPHA (made by Nippon Kayaku Co., Ltd.) serving as a photopolymerizable monomer; 0.1 g of 2,4-bis(trichloromethyl)-6-(4-methoxyphenyl)-1,3,5-s-triazine serving as a photopolymerization initiator; 0.1 g of ORAZOL GN (made by Ciba Speciality Chemicals Inc.) serving as a dye; and 3 g of ethyl lactate.

### Comparative Example 2

A negative-type photosensitive composition for the purpose of comparison was prepared by mixing the following components: 0.17 g of a resin composed of 18% by weight of methacrylic acid and 82% by weight of benzyl methacrylate, serving as a binder polymer; 0.17 g of Kayarad DPHA (made by Nippon Kayaku Co., Ltd.) serving as a photopolymerizable monomer; 0.1 g of 2,4-bis(trichloromethyl)-6-(4-methoxyphenyl)-1,3,5-s-triazine serving as a photopolymerization initiator; 0.1 g of ORAZOL GN (made by Ciba Speciality Chemicals Inc.) serving as a dye; 3 g of ethyl lactate; and 0.0005 g of methyl hydroquinone serving as a polymerization inhibitor.

### Example 2

A negative-type photosensitive composition of the present invention was prepared by mixing the following components: 0.17 g of a resin (weight-average molecular weight 25000) composed of 14% by weight of methacrylic acid and 86% by weight of benzyl methacrylate, serving as a binder polymer; 0.17 g of Kayarad DPHA (made by Nippon Kayaku Co., Ltd.) serving as a photopolymerizable monomer; 0.1 g of CGI-124 (made by Ciba Speciality Chemicals Inc.) serving as a photopolymerization initiator; 0.1 g of Neozapon Yellow 157 (made by BASF) serving as a dye; 3 g of ethyl lactate; and 0.0001 g of N-nitrosophenyl hydroxylamine aluminum salt (made by Wako Pure Chemical Industries, Ltd.) serving as a polymerization inhibitor.

### Comparative Example 3

A negative-type photosensitive composition for the purpose of comparison was prepared by mixing the following components: 0.17 g of a resin composed of 14% by weight of methacrylic acid and 86% by weight of benzyl methacrylate, serving as a binder polymer; 0.17 g of Kayarad DPHA (made by Nippon Kayaku Co., Ltd.) serving as a photopolymerizable monomer; 0.1 g of CGI-124 (made by Ciba Speciality Chemicals Inc.) serving as a photopolymerization initiator; 0.1 g of Neozapon Yellow 157 (made by BASF) serving as a dye; and 3 g of ethyl lactate.

### Comparative Example 4

A negative-type photosensitive composition for the purpose of comparison was prepared by mixing the following components: 0.17 g of a resin composed of 14% by weight of methacrylic acid and 86% by weight of benzyl methacrylate, serving as a binder polymer; 0.17 g of Kayarad DPHA (made by Nippon Kayaku Co., Ltd.) serving as a photopolymerizable monomer; 0.1 g of CGI-124 (made by Ciba Speciality Chemicals Inc.) serving as a photopolymerization initiator; 0.1 g of Neozapon Yellow 157 (made by BASF) serving as a dye; 3 g of ethyl lactate; and 0.0001 g of hydroquinone serving as a polymerization inhibitor.

### Example 3

A negative-type photosensitive composition of the present invention was prepared by mixing the following components: 0.12 g of polyvinyl pyrrolidone (weight-average molecular weight 45000) serving as a binder polymer; 0.24 g of Kayarad DPHA (made by Nippon Kayaku Co., Ltd.) serving as a photopolymerizable monomer; 0.12 g of Irgacure 369 (made by Ciba Speciality Chemicals Inc.) serving as a photopolymerization initiator; 0.1 g of Neozapon Blue 807 (made by BASF) serving as a dye; 3 g of ethyl lactate; and 0.001 g of N-nitrosophenyl hydroxylamine aluminum salt (made by Wako Pure Chemical Industries, Ltd.) serving as a polymerization inhibitor.

### Comparative Example 5

A negative-type photosensitive composition for the purpose of comparison was prepared by mixing the following components: 0.12 g of polyvinyl pyrrolidone serving as a binder polymer; 0.24 g of Kayarad DPHA (made by Nippon Kayaku Co., Ltd.) serving as a photopolymerizable monomer; 0.12 g of Irgacure 369 (made by Ciba Specialty Chemicals Inc.) serving as a photopolymerization initiator; 0.1 g of Neozapon Blue 807 (made by BASF) serving as a dye; and 3 g of ethyl lactate.

### Comparative Example 6

A negative-type photosensitive composition for the purpose of comparison was prepared by mixing the following components: 0.12 g of polyvinyl pyrrolidone serving as a binder polymer; 0.24 g of Kayarad DPHA (made by Nippon Kayaku Co., Ltd.) serving as a photopolymerizable monomer; 0.12 g of Irgacure 369 (made by Ciba Specialty Chemicals Inc.) serving as a photopolymerization initiator; 0.1 g of Neozapon Blue 807 (made by BASF) serving as a dye; 3 g of ethyl lactate; and 0.001 g of methyl hydroquinone serving as a polymerization inhibitor.

The negative-type photosensitive compositions, obtained in examples 1 to 3 and comparative examples 1 to 6, were stored under temperature conditions of 5° C., 23° C. and 50° C. to test the stability with time. Even under the temperature conditions in which gelling was observed in the negative-type photosensitive compositions of comparative examples 1 to 6, no gelling was observed in the negative-type photosensitive compositions of examples 1 to 3.

The negative-type photosensitive compositions obtained in examples 1 to 3 were stored under temperature conditions of 5° C., 23° C. and 50° C. for 10 days, and each of these compositions was applied to a glass substrate with a film thickness of 1 μm by a spin coating method, and pre-baked at 80° C. to form a film. Next, an ultraviolet ray of 365 nm was applied thereto through a predetermined mask pattern by a photolithography method, and this was developed by an aqueous solution containing 0.05% of tetramethyl ammonium oxide and 0.1% of Emulgen A-60 (a surface active agent made by Kao Corpration) for 60 seconds so that the unexposed portion was removed. After having been rinsed with water, this was subjected to processes such as a post-baking so that a negative-type colored cured-film pixel was obtained. Each of the negative-type colored cured-film pixels, obtained in examples 1 to 3, were found to have no difference in sensitivity, shape and spectral properties, independent of storing temperatures.

### Examples 4 to 8

Negative-type photosensitive compositions of the present invention were prepared by mixing the binder polymer, photopolymerizable monomer, photopolymerization initiator, dye, solvent and polymerization inhibitor shown in the following Table. As to the obtained negative-type photosensitive compositions, the same operation as described above were carried out to test the stability with time, and as a result, no gelling was observed. Moreover, in the same manner as described above, negative-type colored cured-film pixels were prepared, and evaluation was made thereon; consequently, these pixels had no difference in sensitivity, shape and spectral properties, independent of storing temperatures.

| | | Photopolymerizable | Photopolymerization | | | Polymerization |
|---|---|---|---|---|---|---|
| Example | Polymer | monomer | initiator | Dye | Solvent | inhibitor |
| 4 | Resin (0.115 g) made from: | DPHA (0.23 g) | 2,4-bis(trichloromethyl)- | ORAZOL Yellow 2RLN | Ethyl | N-nitrosophenyl |
| | Methacrylic acid 15%, Benzyl | | 6-(4-methoxyphenyl)-1, | (0.3 g) (made by Ciba | lactate (3 g) | hydroxylamine |
| | methacrylate 66%, Glycidyl | | 3,5-s-triazine (0.18 g) | Specialty Chemicals | | aluminum salt |
| | methacrylate 19% | | | Ltd.) | | (0.0002 g) |
| 5 | Resin (0.115 g) made from: | DPHA (0.23 g) | 2,4-bis(trichloromethyl)- | Savinyl Blue GLS (0.2 g) | Ethyl | N-nitrosophenyl |
| | Methacrylic acid 18%, Benzyl | | 6-(4-methoxyphenyl)-1, | made by Clariant (Japan) | lactate (3 g) | hydroxylamine |
| | methacrylate 72%, Hydroxy | | 3,5-s-triazine (0.1 g) | K. K. | | aluminum salt |
| | ethyl methacrylate 10% | | | | | (0.00005 g) |
| 6 | Resin (0.115 g) made from: | DPHA (0.18 g) | 2,4-bis(trichloromethyl)- | VALIFAST RED 3312 | Ethyl | N-nitrosophenyl |
| | Methacrylic acid 22.5%, | Pentaerythritol | 6-(4-methoxyphenyl)-1, | (0.4 g) made by Orient | lactate (3 g) | hydroxylamine |
| | Benzyl methacrylate 77.5% | tetracrylate (0.15 g) | 3,5-s-triazine (0.15 g) | Chemical Industries, Ltd. | | aluminum salt |
| | | | | | | (0.0003 g) |
| 7 | Resin (0.8 g) made from: | DPHA (0.25 g) | 2,4-bis(trichloromethyl)- | ORAZOL Orange RG | Ethyl | N-nitrosophenyl |
| | Methacrylic acid 22.5%, | | 6-(4-methoxyphenyl)-1, | (0.4 g) (made by Ciba | lactate (3 g) | hydroxylamine |
| | Benzyl methacrylate 77.5% | | 3,5-s-triazine (0.12 g) | Specialty Chemicals | | aluminum salt |
| | Mariarim AKM0531 (0.3 g) | | | Ltd.) | | (0.0003 g) |
| | made by Nippon Oil & Fats | | | | | |
| | Co., Ltd: | | | | | |
| 8 | Resin (0.115 g) made from: | DPHA (0.15 g) | 2,4-bis(trichloromethyl)- | Savinyl Blue GLS (0.6 g) | Ethyl | N-nitrosophenyl |
| | Methacrylic acid 22.5%, | Pentaerythritol | 6-(4-methoxyphenyl)-1, | made by Clariant (Japan) | lactate (3 g) | hydroxylamine |
| | Benzyl methacrylate 77.5% | tetracrylate (0.15 g) | 3,5-s-triazine (0.15 g) | K. K. Neozapon Yellow | | aluminum salt |
| | | | | 157 (0.4 g) (made by | | (0.0002 g) |
| | | | | BASF) | | |

### Industrial Applicability

In the present invention, n-nitrosophenyl hydroxylamine salt is added to the negative-type colored photosensitive composition as a polymerization inhibitor so that it becomes possible to provide a negative-type colored photosensitive composition used for manufacturing a color filter that is superior in storage stability without losing inherent properties of the negative-type colored photosensitive composition, such as smoothness, resolution, shape, heat resistance, light resistance, spectral properties.

1. A negative-type colored photosensitive composition comprising:
a binder polymer, a photopolymerizable monomer or oligomer, a photopolymerization initiator, a polymerization inhibitor, a dye containing a transition metal and soluble to an organic solvent, and an organic solvent,
wherein the polymerization inhibitor is an N-nitrosophenyl hydroxylamine salt.

2. The negative-type colored photosensitive composition according to claim 1, wherein the N-nitrosophenyl hydroxylamine salt is an ammonium salt or a metal salt of N-nitrosophenyl hydroxylamine.

3. The negative-type colored photosensitive composition according to claim 1 or 2, wherein the binder polymer is an alkali soluble resin.

4. The negative-type colored photosensitive composition according to claim 1 or 2, wherein the binder polymer is a water-soluble resin.

5. (Deleted)

6. A method for preparing a color filter, wherein: the negative-type colored photosensitive composition according to any one of claims 1 to 5 is applied to a substrate, and after exposure to light, the exposed portion is cured, and the non-exposed portion is developed and removed by an active agent aqueous solution and/or an alkali aqueous solution, and is rinsed by water.

7. A color filter wherein: among the color filter pixels prepared by the method according to claim 6, at least pixels of one color are cured films of the negative-type colored photosensitive composition according to any one of claims 1 to 5.

8. A liquid crystal display element having a color filter according to claim 7.

9. A solid-state image-pickup element having a color filter according to claim 7.
